(19) United States
(12) Patent Application Publication
(10) Pub. No.: US 2002/0167107 A1
(43) Pub. Date: Nov. 14, 2002

(54) Process for manufacturing granulated hydrophilic resin

(76) Inventor: Toshikazu Akao, Kyoto (JP)

Correspondence Address: MARSHALL, GERSTEIN & BORUN, 6300 SEARS TOWER, 233 SOUTH WACKER, CHICAGO, IL, 60606-6357, US

(21) Appl. No.: 10/138,081

(22) Filed: May 3, 2002

(30) Foreign Application Priority Data
May 9, 2001 (JP) 2001-138828

(51) Int. Cl. B29B 9/00

(52) U.S. Cl. 264/141

(57) ABSTRACT

Granulated hydrophilic resins are manufactured by: an extrusion step to melt and extrude a hydrophilic resin; a cooling step to obtain a solidified resin by solidifying with cooling thus extruded resin through the contact with a metal plate; and a granulating step to obtain a granulated hydrophilic resin by the granulation of thus solidified resin. The resulting granulated hydrophilic resins can be used for the extrusion molding and the like.

### FIELD OF THE INVENTION

The present invention relates to a process for manufacturing a granulated hydrophilic resin. More specifically, the present invention relates to a process for manufacturing a granulated hydrophilic resin, which is suitable for use as a raw material for the molding fabrication such as extrusion molding.

### BACKGROUND OF THE INVENTION

Extrusion molding, in which an extruder is used, has been often carried out in the fabrication of thermoplastic resins that are used in the manufacture of molded articles, films, vessels and the like. In the extrusion molding, previously pelletized resins are used, and they are melted and fed into an extruder, in general.

When the resin used in the extrusion molding is selected from resins that are insoluble in water, for example, PP (polypropylene), PE (polyethylene), ABS (acrylonitrile-butadiene-styrene copolymer), PET (polyethylene terephthalate) and the like, methods have been adopted wherein: melted resins are extruded into a thread-like shape with an extruder, solidified by water cooling, and then pellets are obtained using a slide cutter or the like.

However, when hydrophilic resins, in particular an alkylene oxide polymer containing ethylene oxide is used, the above-described methods cannot be employed because such a resin has comparatively low melting point and have great rate of dissolution or of water absorption. Therefore, when hydrophilic resins have been used so far, the hydrophilic resins have been previously subjected to powderization in the steps for manufacturing, and thus resulting powder is fed into an extruder by the common practice. However, upon feeding of the resin powder into an extruder, constant quantity feeding of the resin may often be difficult due to the occurrence of the surging, thereby leading to the problems of impossibilities in obtaining the molded products intended.

The present invention was accomplished to solve the aforementioned problems. The object of the present invention is to provide processes for manufacturing granulated hydrophilic resins, which can be employed in extrusion molding and the like.

### SUMMARY OF THE INVENTION

As a consequence of elaborate investigations to achieve the granulation of hydrophilic resins having a low melting point in view of the aforementioned problems, the present inventors found that the granulation of hydrophilic resins is enabled at a practical rate of production by: an extrusion step to melt and extrude a hydrophilic resin; a cooling step to obtain a solidified resin by solidifying with cooling thus extruded resin through the contact with a metal plate; and a granulating step to obtain a granulated hydrophilic resin by the granulation of thus solidified resin. Accordingly, the present invention could be accomplished.

Further, the present inventors also found that the granulation of hydrophilic resins is enabled at a practical rate of production by: an extrusion step to melt and extrude a hydrophilic resin to result in a plate-like shape having a predetermined thickness; a cooling step to obtain a solidified resin by solidifying with cooling thus extruded resin having a plate-like shape through the contact with a metal plate at both sides or one side of thus extruded resin having a plate-like shape; and a granulating step to obtain a granulated hydrophilic resin by the granulation of thus solidified resin. Accordingly, the present invention could be accomplished.

The term “hydrophilic” herein refers to a water absorptive resin having a percentage of water absorption of 100% by weight or greater on the basis of weight of a water-soluble resin and a resin.

### DESCRIPTION OF THE PREFERRED EMBODIMENT

The present invention is described in more detail below. The hydrophilic resins that may be used in the process for manufacturing a granulated hydrophilic resin according to the present invention refer to thermoplastic resins that are water soluble or water absorptive as described above. In particular, when an alkylene oxide polymer containing ethylene oxide that exhibits low fluidity is intended, the present invention can be suitably adopted.

The process for the manufacture according to the present invention is suitably applied when a thermoplastic resin having a pour point of 50 to 200° C. is used as a hydrophilic resin. When the hydrophilic resin that is thermoplastic has a pour point of less than 50° C., cooling efficiency may be significantly deteriorated. To the contrary, when the hydrophilic resin that is thermoplastic has a pour point of greater than 200° C., solidifying with cooling may be facilitated to result in the loss of the significance to apply the present invention.

Moreover, when an alkylene oxide polymer containing an ethylene oxide is used as a hydrophilic resin, the molecular weight thereof is not particularly limited, however, the polymer may preferably have a molecular weight in the range of from 50,000 to 300,000. When the molecular weight of the polymer is less than 50,000, the characteristics as the resin may not be exhibited. Such a low molecular weight of a polymer is not preferable because cracks upon flexion are apt to occur in some cases where the resin is formed into a sheet, for example. Additionally, when the molecular weight of the polymer is greater than 300,000, the melt viscosity may be elevated, and thus increase in the extrusion amount may become difficult in some cases during the extrusion step where the melted resin is extruded.

In the present invention, organic or inorganic fine particles may also be added to the hydrophilic resin as needed. The fine particles may be added for the purpose of preventing blocking in compliance with the intended purpose and with the type of usage of the hydrophilic resin. The organic particles that can be used include for example, polystyrene, polyethylene, polypropylene and the like. Examples of the inorganic particles include silica, alumina, zirconia, compound oxides and the like. However, these particles are not particularly limited to the above examples. Furthermore, multiple kinds of fine particles may also be added. In the present invention, antioxidants, antiseptic agents, light resistance improvers and the like may be added in compliance with the intended use of the resin.

The process for manufacturing a granulated hydrophilic resin according to the present invention comprises an extrusion step in which a hydrophilic resin is melted, and the melted resin is extruded using an extruder or the like. In order to sufficiently cool the resin in the subsequent cooling step, the resin is preferably extruded to result in a plate-like shape having a predetermined thickness. Favorable procedure for extruding the melted hydrophilic resin into a plate-like shape having a predetermined thickness may involve an extrusion procedure in which the melted resin is subjected to the concurrently conducted extraction and extrusion using a reaction vessel equipped with an extruder or a polymer pump at the bottom thereof after the synthetic reaction of the resin was completed. In addition, the procedure for the extrusion of a resin to yield a predetermined thickness may involve a T-die mounted onto a tip of a pipe arrangement.

In the extrusion step, melt viscosity of the melted resin is not particularly limited as long as a predetermined thickness can be provided, however, the melt viscosity of 200 to 3,000 Pa·s is preferred. When the melt viscosity is less than 200 Pa·s, the thickness of the melted resin that is discharged from T-die or the like is liable to vary. To the contrary, when the viscosity is greater than 3,000 Pa·s, discharging of the resin with a predetermined thickness may be difficult. Thickness of the resin in a plate-like shape extruded in this step in general, may be suitably from 0.5 to 4 mm, taking into account of the cooling efficiency in the next cooling step, and of the granular size finally yielded.

In the next cooling step, the melted resin that was extruded from the T-die or the like is cured upon cooling through the contact with a metal plate. The cooling procedure may involve blowing cool air onto the melted resin, however, it is suitable to adopt the procedure in which a drum cooler, W-steel band belt or the like is used to cool and cure the resin by spraying a cooling medium from the rear face of the metal surface to the side contacted with the resin. In any of the procedures, the melted resin that was discharged onto the cooled metal plate is cured with cooling while being fed. Specifically, when a W-steel band belt is used, conditions that allow optional amount of the production can be readily achieved by the selection of the cooling belt, the temperature of the cooling medium and the sort of the cooling medium, as well as the selection of the width of the T-die and the width of the W-steel. In such a manner, the process for the manufacture according to the present invention can be suitably practiced. The cooling temperature of the resin is desirably lower than the melting point of the resin to be granulated by 20° C. or greater.

After being cured with cooling, the resin is then subjected to the granulation by the cutting, grinding and the like in the granulating step. Although sheet pelletizing machines or crushing machines can be used for the granulating step, a sheet pelletizing machine is suitably used in respect to feasibility of the uniform particle size of the resulting granules. Although there are sheet pelletizing machines having wide variety of structures, those preferred for cutting the resin having a low pour point may be of the structure in which a cutter part, in particular a slitter role part, can be cooled with a cooling medium. In order to use a sheet palletizing machine in an efficient manner, it is preferable to feed the solidified resin having a plate-like shape with a width of 80% of the width of the slitter role. Therefore, this cutting step is also included in the granulating step when the step for the cutting is provided in the present invention, in which the resin sheet that was cured with cooling is cut while being divided using a slitter prior to the cutting with a sheet palletizing machine.

Because a hydrophilic resin is dealt with in the process for the manufacture according to the present invention, to carry out the entire steps for the manufacture in a dry atmosphere is effective in view of preventing the resin from absorbing the moisture. Through carrying out the granulating step in a dry atmosphere, condensation of the moisture in the atmospheric air to the cooling part of the slitter role or the like of the sheet pelletizing machine can be prevented. Thus, mutual fusion of the granules upon cutting can be prevented. The temperature of the dry atmosphere is determined on the basis of the moisture absorption property and the amount of permissible moisture of the resin, however, it is preferably below the dew point by 10° C. or greater.

In the present invention, selection step may be further provided for giving uniform granules of the resin that were obtained in the granulating step. Common sieves can be used in the selection step, however, e.g., a shaking sieve with which selection is executed by subjecting the granular resin to fluidization on the inclined-face of the sieve while imparting the vibration, or a trommel sieve with which selection is executed while rotating the granules on the inclined-face of the sieve having a trumpet shape in itself and of the horizontal type, or the like may be suitably used, taking into account of the productivity in the steps for the manufacture. The granular resin obtained in the granulating step is preferably selected through directly introducing into such a sieve.

In accordance with the process for manufacturing the granulated hydrophilic resin of the present invention, the hydrophilic resin is extruded to result in a predetermined shape such as plate-like shape or the like in a molten state, and thereafter cured with cooling through the contact with a metal plate followed by the granulation. Therefore, because the process for the manufacture according to the present invention excludes a step of contact of the resin with cooling water, granulated hydrophilic resin can be obtained which is suitable for use as a raw material for the molding fabrication such as extrusion molding and the like.

### EXAMPLES

The process for manufacturing granulated hydrophilic resin according to the present invention is illustrated by the following examples. However, these examples should not be construed as any limitation of the scope of the present invention.

### Example 1

Polyureapolyol (molecular weight: 125,000, pour point: 85° C.) resulting from a reaction of PEO6000 diamine (molecular weight: 8,000) and hexamethylenediisocyanate MEK oxime block was melted in a vessel at the inner temperature of 160° C. The melt viscosity was then about 1,400 Pa·s. The melted resin was discharged from the bottom of the vessel equipped with a polymer pump to give the width of 60 cm, and the thickness of 2.2 mm onto a predetermined surface of a W-steel belt. The amount of the melted resin discharged was set to be 400 kg/H. The W-steel belt used in this step had a width of 80 cm, a length of 13 m, and a speed thereof was 10 m/min. A cooling medium of 20° C. was sprayed from the rear face of the metal surface to the side of the W-steel belt contacted with the resin. In this Example 1, the measured temperature of the sheet surface that was cured with cooling at the outlet of the W-steel belt was 25° C.

Next, this resin sheet was cut using a sheet palletizing machine to give the width of 4 mm, and the length of 4 mm. Thereafter, particle size classification was carried out with a rotating type sieve machine. The percent defective of the granules having defective sizes excluded by the sieve machine was 0.2%. In the measurement of the particle diameter as well, variation of the width, length, and thickness was within 15%.

### Example 2

The powder of a ternary polymer of polyalkyleneoxide (molecular weight: 100,000, melt viscosity: 800 Pa·s/80° C., pour point: 63° C.) consisting of ethylene oxide, methylglycidyl ether and allylglycidyl ether was prepared. The melt of this ternary polymer of polyalkyleneoxide was discharged into a sheet shape having the width of 20 cm and the thickness of 15 mm using an extruder equipped with a T-die at a tip thereof. This procedure was conducted under a condition of the extruder with the inner temperature of the cylinder is 70° C., and the temperature of the T-die of 80° C. In addition, the temperature of the melt that was discharged was 85° C.

Next, the discharged material was dropped on a small-scale drum cooler (diameter: 30 cm, length: 30 cm) at 15 cm/min. Cooling water of 15° C. was circulated in the drum cooler. The surface temperature of the ternary polymer of polyalkyleneoxide that was cured with the drum cooler was 25° C. Thus resulting sheet was cut using a sheet palletizing machine into the width of 4 mm and the length of 4 mm similarly to the procedure in Example 1. Thereafter, particle size classification was carried out with a rotating type sieve machine. The percent defective of the granules having defective sizes excluded by the sieve machine was 0.3%. In the measurement of the particle diameter as well, variation of the width, length, and thickness was within 15%.

### Example 3

Water absorptive polyether ester (molecular weight: 150,000, melt viscosity: 1,600 Pa·s/150° C., pour point: 81° C.) resulting from a reaction of polybutyleneglycol-polyethyleneglycol (molecular weight: 20,000) containing 10% butyleneoxide and icosane diacid dimethyl was melted in a vessel at the inner temperature of 150° C. in a similar manner to that in Example 1. The melted resin was discharged from a polymer pump to give the width of 60 cm and the thickness of 2.3 mm onto a predetermined surface of a W-steel belt. The amount of the melted resin discharged was set to be 450 kg/H. The W-steel belt used in this step was the same as that in Example 1, and the speed thereof was 11 m/min. A cooling medium of 20° C. was sprayed from the rear face of the metal surface to the side of the W-steel belt contacted with the resin. In this Example 3, the measured temperature of the sheet surface that was cured with cooling at the outlet of the W-steel belt was 26° C.

Next, this resin sheet was cut using a sheet palletizing machine to give the width of 4 mm and the length of 4 mm. Thereafter, particle size classification was carried out with a rotating type sieve machine. The percent defective of the granules having defective sizes excluded by the sieve machine was 0.2%. In the measurement of the particle diameter as well, variation of the width, length, and thickness was within 15%.

What is claimed is:

1. A process for the manufacture of a granulated hydrophilic resin comprising:
an extrusion step to melt and extrude a hydrophilic resin;
a cooling step to obtain a solidified resin by solidifying with cooling thus extruded resin through the contact with a metal plate; and
a granulating step to obtain a granulated hydrophilic resin by the granulation of thus solidified resin.

2. A process for the manufacture of a granulated hydrophilic resin comprising:
an extrusion step to melt and extrude a hydrophilic resin to result in a plate-like shape having a predetermined thickness;
a cooling step to obtain a solidified resin by solidifying with cooling thus extruded resin having a plate-like shape through the contact with a metal plate at both sides or one side of thus extruded resin having a plate-like shape; and
a granulating step to obtain a granulated hydrophilic resin by the granulation of thus solidified resin.

3. The process for the manufacture of a granulated hydrophilic resin according to claim 1 further comprising a selection step to select a particle size of said granulated hydrophilic resin.

4. The process for the manufacture of a granulated hydrophilic resin according to claim 1, wherein solidifying with cooling in said cooling step is conducted through the contact with a cooling medium from the rear face of said metal plate.

5. The process for the manufacture of a granulated hydrophilic resin according to claim 1, wherein the granulation in said granulating step is carried out using a sheet pelletizing machine.

6. The process for the manufacture of a granulated hydrophilic resin according to claim 1, wherein said granulating step is carried out in a dry atmosphere.

7. The process for the manufacture of a granulated hydrophilic resin according to claim 1, wherein said granulated hydrophilic resin is a thermoplastic resin having a pour point of 50-200° C.

8. The process for the manufacture of a granulated hydrophilic resin according to claim 1, wherein said hydrophilic resin in said extrusion step has a melt viscosity of 200-3,000 Pa·s.

9. The process for the manufacture of a granulated hydrophilic resin according to claim 7, wherein said hydrophilic resin is a polyalkyleneoxide polymer containing ethylene oxide.

10. The process for the manufacture of a granulated hydrophilic resin according to claim 8, wherein said hydrophilic resin is a polyalkyleneoxide polymer containing ethylene oxide.

11. The process for the manufacture of a granulated hydrophilic resin according to claim 9, wherein said polyalkyleneoxide polymer has a weight-average molecular weight of 50,000-300,000.

12. The process for the manufacture of a granulated hydrophilic resin according to claim 10, wherein said polyalkyleneoxide polymer has a weight-average molecular weight of 50,000-300,000.

13. The process for the manufacture of a granulated hydrophilic resin according to claim 1, wherein said hydrophilic resin contains organic or inorganic fine particles for the purpose of preventing blocking.

14. The process for the manufacture of a granulated hydrophilic resin according to claim 13, wherein said organic particles are polymer particles selected from the group consisting of polystyrene, polyethylene and polypropylene.

15. The process for the manufacture of a granulated hydrophilic resin according to claim 13, wherein said inorganic particles are inorganic particles selected from the group consisting of silica, alumina and zirconia.

16. The process for the manufacture of a granulated hydrophilic resin according to claim 2 further comprising a selection step to select a particle size of said granulated hydrophilic resin.

17. The process for the manufacture of a granulated hydrophilic resin according to claim 2, wherein solidifying with cooling in said cooling step is conducted through the contact with a cooling medium from the rear face of said metal plate.

18. The process for the manufacture of a granulated hydrophilic resin according to claim 2, wherein the granulation in said granulating step is carried out using a sheet pelletizing machine.

19. The process for the manufacture of a granulated hydrophilic resin according to claim 2, wherein said granulating step is carried out in a dry atmosphere.

20. The process for the manufacture of a granulated hydrophilic resin according to claim 2, wherein said granulated hydrophilic resin is a thermoplastic resin having a pour point of 50-200° C.

21. The process for the manufacture of a granulated hydrophilic resin according to claim 2, wherein said hydrophilic resin in said extrusion step has a melt viscosity of 200-3,000 Pa·s.

22. The process for the manufacture of a granulated hydrophilic resin according to claim 20, wherein said hydrophilic resin is a polyalkyleneoxide polymer containing ethylene oxide.

23. The process for the manufacture of a granulated hydrophilic resin according to claim 21, wherein said hydrophilic resin is a polyalkyleneoxide polymer containing ethylene oxide.

24. The process for the manufacture of a granulated hydrophilic resin according to claim 2, wherein said hydrophilic resin contains organic or inorganic fine particles for the purpose of preventing blocking.

25. The process for the manufacture of a granulated hydrophilic resin according to claim 13, wherein said inorganic particles are inorganic particles selected from the group consisting of silica, alumina and zirconia.
